(19) United States
(12) Patent Application Publication
(10) Pub. No.: US 2014/0285479 A1
(43) Pub. Date: Sep. 25, 2014

(54) CONTROL APPARATUS, ELECTRO-OPTIC APPARATUS, ELECTRONIC DEVICE, AND CONTROL METHOD

(71) Applicant: SEIKO EPSON CORPORATION, Tokyo (JP)

(72) Inventors: Toshimichi YAMADA, Fujimi-machi (JP); Kota MUTO, Suwa-shi (JP); Hiroaki KANAMORI, Suwa-shi (JP); Atsushi MIYAZAKI, Suwa-shi (JP)

(73) Assignee: SEIKO EPSON CORPORATION, Tokyo (JP)

(21) Appl. No.: 14/191,968

(22) Filed: Feb. 27, 2014

(30) Foreign Application Priority Data
Mar. 19, 2013 (JP) 2013-056301

(51) Int. Cl. G09G 5/00

(52) U.S. Cl. CPC G09G 5/00
USPC 345/212

(57) ABSTRACT

In a refresh period, a voltage for alternatingly inverting a memory display element between a first gray level and a second gray level is applied. The number of inversions in the refresh period when the temperature of the memory display element is low is lower than the number of inversions in the refresh period when the temperature of the memory display element is high.

### BACKGROUND

1. Technical Field

The present invention relates to a technique for controlling the driving of a memory display element.

2. Related Art

Recent years have seen the widespread use of memory display elements in which each pixel can only display two gray levels (e.g., black and white). In order to raise image quality, techniques that enable each pixel to display many gray levels have been developed, JP-T-2007-513368 discloses a technique for expressing grayscales (intermediate gray levels) other than black and white in an electrophoretic display device, which is one type of memory display element (FIG. 1, etc.).

JP-T-2007-513368 is an example of related art.

### SUMMARY

In the technique disclosed in JP-T-2007-513368, if the drive waveform is designed for each temperature zone, there are cases where the low-temperature drive waveform is longer (driving is slower), and ghosts appear with the high-temperature drive waveform.

In view of this, this invention provides a technique for further suppressing ghosts in high-temperature driving, and shortening the drive time in low-temperature driving.

A first aspect of this invention provides a control, apparatus including: an acquisition unit that acquires image data indicating an image to be displayed on a memory display element whose optical state shifts from a first gray level to a second gray level due to application or a first voltage and shifts from the second gray level to the first gray level due to application of a second voltage; and a control unit that controls a drive circuit that drives the memory display element, so as to apply a voltage that corresponds to the image data to the memory display element, wherein in order to set the optical state of the memory display element to a gray level indicated by the image data, the control unit controls the drive circuit so as to apply a voltage that corresponds to a pattern of voltage application in a plurality of periods that include a refresh period and a write period, the refresh period is a period in which a voltage for alternatingly inverting the memory display element between the first gray level and the second gray level is applied, and the number of inversions in the refresh period in a case where the memory display element is at a first temperature is lower than the number of inversions in the refresh period in a case where the memory display element is at a second temperature that is higher than the first temperature.

According to this control apparatus, it is possible to further suppress ghosts in high-temperature driving. This also enables shortening the drive time in low-temperature driving.

The pattern may further include an erase period for setting the gray level of the memory display element at the beginning of the refresh period to the second gray level, the refresh period may be a period in which a voltage for setting the gray level of the memory display element at the end of the refresh period to the first gray level is applied, and the write period may be a period in which a voltage for causing the gray level of the memory display element that is the first gray level at the beginning of the write period to shift to a gray level indicated by the image data is applied,

According to this control apparatus, it is possible to raise gray level reproducibility.

In the pattern, the length of a period in which a voltage for causing the gray level of the memory display element to shift from the first gray level to the second gray level is applied may be equal to the length of a period in which a voltage for causing the gray level of the memory display element to shift from the second gray level, to the first gray level is applied.

According to this control apparatus, it is possible to maintain DC balance in the memory display element.

The pattern may he defined according to a pre-rewriting gray level, a post-rewriting gray level, and a temperature zone, and in at least one of a case where the post-rewriting gray level is the first gray level and a case where the post-rewriting gray level is the second gray level when the prewriting gray level is the same, the number of inversions may be different between the pattern that corresponds to a first temperature zone and the pattern that corresponds to a second temperature cone that is higher than the first temperature zone.

According to this control apparatus, it is possible to further suppress ghosts in high-temperature driving by using patterns having different numbers of inversions. This also enables shortening the drive time in low-temperature driving.

In both the case where the post-rewriting gray level is the first gray level and the case where the post-rewriting gray level is the second gray level when the pre-writing gray level is the same, the number of inversions may foe different between the pattern that corresponds to the first temperature zone and the pattern that corresponds to the second temperature zone that is higher chart the first temperature zone.

According to this control apparatus, it is possible to further suppress ghosts in high-temperature driving for all of the patterns. This also enables shortening the drive time in low-temperature driving.

The pattern may be a pattern in which one of the first voltage and the second voltage is applied for each unit period, the applied voltage being a voltage for causing a gray level change that corresponds to a portion of a loop to occur in conformity with the loop, the loop being a loop of shifting from the second gray level to the first gray level and then returning to the second gray level.

According to this control apparatus, it is possible to raise gray level reproducibility.

This control apparatus may further include: a first storage unit that stores current data indicating an image that is currently being displayed on the memory display element; a second storage unit that stores next data indicating an image that is to be displayed next on the memory display element; a counting unit that counts the number of unit periods for which voltage application has ended among the plurality of unit periods included in the pattern; and a third storage unit that, for each of a plurality of gray level values, stores a pre-rewriting gray level value, a post-rewriting gray level value, and a pattern of voltage application that corresponds to the pre-rewriting gray level, value and the post-rewriting gray level value, wherein the acquisition unit may acquire the current data from the first storage unit and acquires the next data from the second storage unit, and the control unit may control the drive circuit that drives the memory display element, so as to apply to the memory display element, among the voltages indicated by the plurality of patterns stored in the third storage unit, the voltage that is to be applied in the unit period that corresponds to the current data and the next data that were acquired by the acquisition unit and corresponds to the number counted by the counting unit.

A second aspect of this invention provides an electro-optic apparatus including: a memory display element whose optical, state shifts from a first gray level to a second gray level due to application of a first voltage and shifts from the second gray level to the first gray level due to application of a second voltage; an acquisition unit that acquires image data indicating an image to be displayed on the memory display element; and a control unit that controls a drive circuit that drives the memory display element, so as to apply a voltage that corresponds to the image data to the memory display element, wherein in order to set the optical state of the memory display element to a gray level indicated by the image data, the control unit controls the drive circuit so as to apply a voltage that corresponds to a pattern of voltage application in a plurality of periods that include a refresh period and a write period, the refresh period is a period in which a voltage for alternatingly inverting the memory display element between the first gray level and the second gray level is applied, and the number of inversions in the refresh period in a case where one memory display element is at a first temperature is lower than the number of inversions in the refresh period in a case where the memory display element is at a second temperature that is higher than the first temperature.

According to this electro-optic apparatus, it is possible to further suppress ghosts in high-temperature driving. This also enables shortening the drive time in low-temperature driving.

A third, aspect of this invention provides an electronic device including the above-described electro-optic apparatus.

According to this electronic device, it is possible to further suppress ghosts in high-temperature driving. This also enables shortening the drive time in low-temperature driving.

A fourth aspect of this invention provides a control method of an electro-optic apparatus, including: acquiring image data indicating an image to be displayed on a memory display element whose optical state shifts from a first gray level to a second gray level due to application of a first voltage and shifts from the second gray level to the first gray level due to application of a second voltage; and applying, in order to set the optical state of the memory display element to a gray level indicated by the image data, a voltage that corresponds to a pattern of voltage application in a plurality of periods that include a refresh period and a write period, wherein the refresh period is a period in which a voltage for alternatingly inverting the memory display element between the first gray level and the second gray level is applied, and the number of inversions in the refresh period in a case where the memory display element is at a first temperature is lower than the number of inversions in the refresh period in a case where the memory display element is at a second temperature that is higher than the first temperature.

According to this control method, it is possible to further suppress ghosts in high-temperature driving.

### BRIEF DESCRIPTION OF THE DRAWINGS

FIG. 1 is a diagram showing an example of the relationship between voltage application and the optical state of an EPD.

FIG. 2 is a diagram showing an example of drive modes used in an embodiment of this invention.

FIG. 3 is a diagram showing an example of voltage application patterns used in an embodiment of this invention.

FIG. 4 is a diagram showing an example of an ghost characteristic relative to the basic number of frames.

FIGS. 5A and 5B are diagrams showing examples of drive waveforms and gray level change in an LG mode,

FIGS. 6A and 6B are diagrams showing examples of drive waveforms and gray level change in an LF mode.

FIGS. 7A and 7B are diagrams showing examples of drive waveforms and gray level change in an HS mode.

FIG. 8 is a diagram showing a configuration of an electronic device 1 according to an embodiment.

FIG. 9 is a schematic diagram showing a cross-sectional structure of an electro-optic panel 10.

FIG. 10 is a diagram showing a circuit configuration of the electro-optic panel 10.

FIG. 11 is an equivalent circuit diagram of a pixel 14.

FIG. 12 is a diagram showing an example of a configuration of a controller 20.

FIG. 13A is a diagram showing an example of high-temperature drive waveforms.

FIG. 13B is a diagram showing an example of room-temperature drive waveforms.

FIG. 13C is a diagram showing an example of low-temperature drive waveforms.

FIGS. 14A and 14B are diagrams showing examples of an ghost characteristic when using the drive waveforms in FIGS. 13A to 13C.

FIG. 15 is a diagram showing an example of a table stored in an LUT 24.

FIG. 16 is a flowchart showing operations of the electronic device 1.

FIGS. 17A and 17B are diagrams showing examples of images displayed on the electro-optic panel 10.

FIG. 18A is a diagram showing an example of high-temperature drive waveforms.

FIG. 18B is a diagram showing an example of room-temperature drive waveforms.

FIG. 18C is a diagram showing an example of low-temperature drive waveforms.

### DESCRIPTION OF EXEMPLARY EMBODIMENTS

1. Principle

1-1. Overview

Before giving a description of the specific configuration, and operations of apparatuses of an embodiment of this invention, a description of the principle of driving will be given. The following description is given taking the example in which an EPD (Electro Phonetic Display) is used as the electro-optic device, and each pixel can display four gray levels.

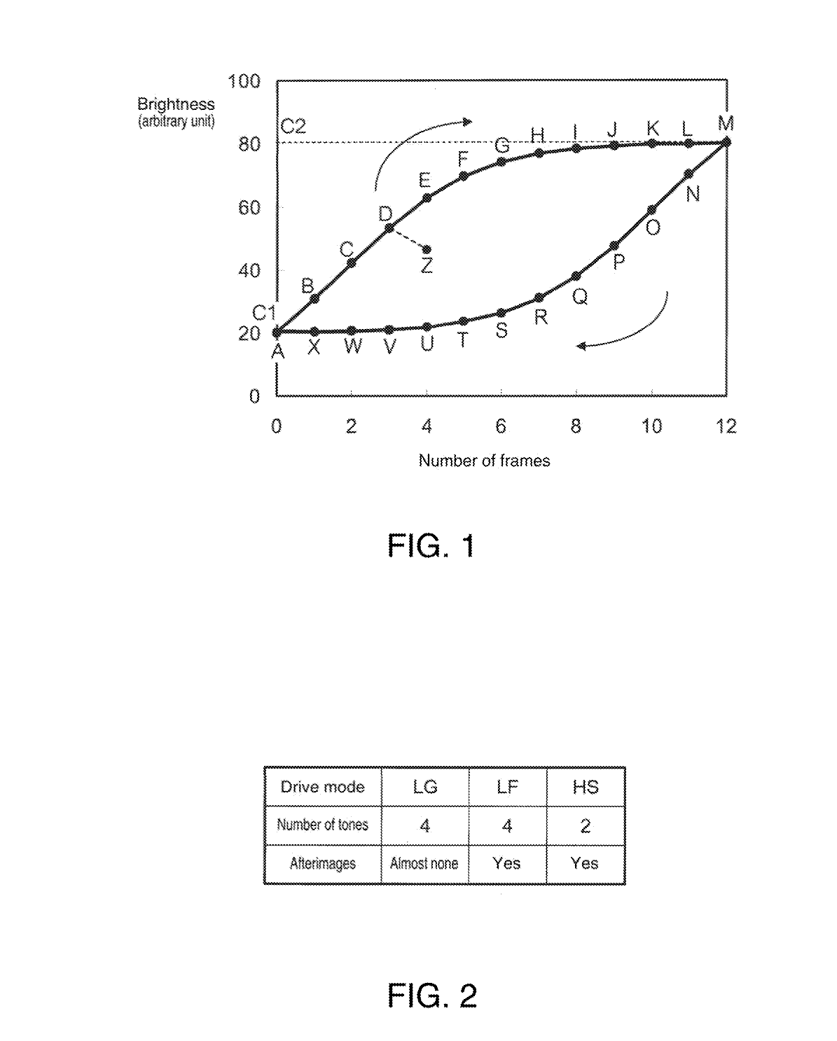

FIG. 1 is a diagram showing an example of the relationship between voltage application and the optical state of an EPD. In FIG. 1, the number of frames for which voltage is applied is indicated on the horizontal axis, and the optical state of the EPD, which in this example is the brightness of the EPD, is indicated on the vertical axis. Here, “frame” refers to the unit of voltage application duration, and the frame length is determined in advance (e.g., 40 ms, which corresponds to 25 Hz). The brightness C1 corresponds to black, and the brightness C2 corresponds to white.

Consider the example of starting voltage application when the brightness is the brightness C1. The optical state before voltage application is indicated by point A. If a predetermined first voltage (e.g., −15 V) is then applied for one frame, the brightness of the EPD increases a little and shifts to point B. If the first voltage is applied for one more frame, the brightness of the EPD increases further and shifts to point C. As the first voltage is further applied in a similar manner, the brightness of the EPD shifts to point D, point E, point F, point G, point H, point I, point J, point K, point L, and point M in the stated order. Point M corresponds to the brightness C2, that is to say corresponds to white. In this way, in this example, the brightness shifts from black to white as the first voltage is applied over 12 frames.

If a predetermined second voltage (e.g., +15 V) is applied for one frame when the brightness is the brightness C2, the brightness of the EPD decreases a little and shifts to point N. Note that in order to simplify the description, the number of frames decreases in FIG. 1 when the second voltage is applied. If the second voltage is applied for one more frame, the brightness of the EPD decreases further and shifts to point O. As the second voltage is further applied in a similar manner, the brightness of the EPD shifts to point P, point Q, point R, point S, point T, point U, point V, point W, point X, and point A in the stated order. The optical states that the memory display element goes through as the brightness shifts from white to black are different from those that it goes through as the brightness shifts from black to white. Specifically, when the first voltage is applied for 12 frames, and then the second voltage is applied for 12 frames, the brightness of the EPD exhibits a loop-shaped shift characteristic of shifting from black to white and then returning to black again. This loop is shown with a solid line in FIG. 1.

Next, consider the case where the second voltage is applied instead of the first voltage at point D during the shift from black to white, for example. If the second voltage is applied for one frame at point D, the brightness decreases from point D and shifts no point Z. Point Z is not on the loop described above, and the brightness at point Z is different from that at point C. If the first voltage or the second voltage is then applied at point Z, it is difficult to predict how the brightness will change. In this way, if, during the shift from black to white, a voltage for causing a shift in the opposite direction (i.e., the second voltage for causing a shift from white to black) is applied, the change in the brightness of the EPD will deviate from the above-described loop, and control will become difficult. If gray level control becomes difficult, it is possible for the ability to reproduce intermediate gray levels between black and white to become poor, and for the order of intermediate gray levels to become inverted (e.g., dark, gray will be brighter than light gray).

In view of this, in this embodiment, the EPD is driven so as to prevent a situation in which during a shift between two gray levels that are references (e.g., black and white), a voltage for causing a shift in the opposite direction is applied. Specifically; in this embodiment, voltage application that conforms to the loop shown in FIG. 1 is performed. The voltage that is applied in each frame is a voltage that, causes a change in gray level that corresponds to one portion of the loop shown in FIG. 1.

1-2. Drive Mode

EPDs have the problem that the response speed of the device itself is inherently slow (in comparison to liquid crystal displays and the like). When performing high-quality rewriting so as to prevent ghosts from appearing, the time required for rewriting a screen approximately 10 inches in size is on the order of several seconds. Although various techniques for increasing the speed of rewriting have been developed, ghosts end up appearing when the speed of rewriting is increased. In this way, there is a trade-off relationship between rewriting speed and ghosts in EPD driving, and it has been extremely difficult to both increase the rewriting speed and perform driving without ghosts appearing. In view of this, in this embodiment, three drive modes having different rewriting speeds are prepared, and these drive modes are used according to the situation.

FIG. 2 is a diagram showing an example of drive modes used in this embodiment. The three drive modes LG, LF, and HS are used in this embodiment. The LG (Low Ghosting) mode is a drive mode for performing nigh quality (i.e., the lowest degree of ghost appearance) rewriting, but on the other hand, the rewriting speed is the lowest. The HS (High Speed) mode is a drive mode for performing the fastest rewriting, but on the other hand, only two gray levels can be expressed, and ghosts also appear. The LF (Low Flashing) mode is an intermediate drive mode between the LG mode and the HS mode, and both the rewriting speed and appearance of ghosts in this mode are between these in the LG mode and the HS mode.

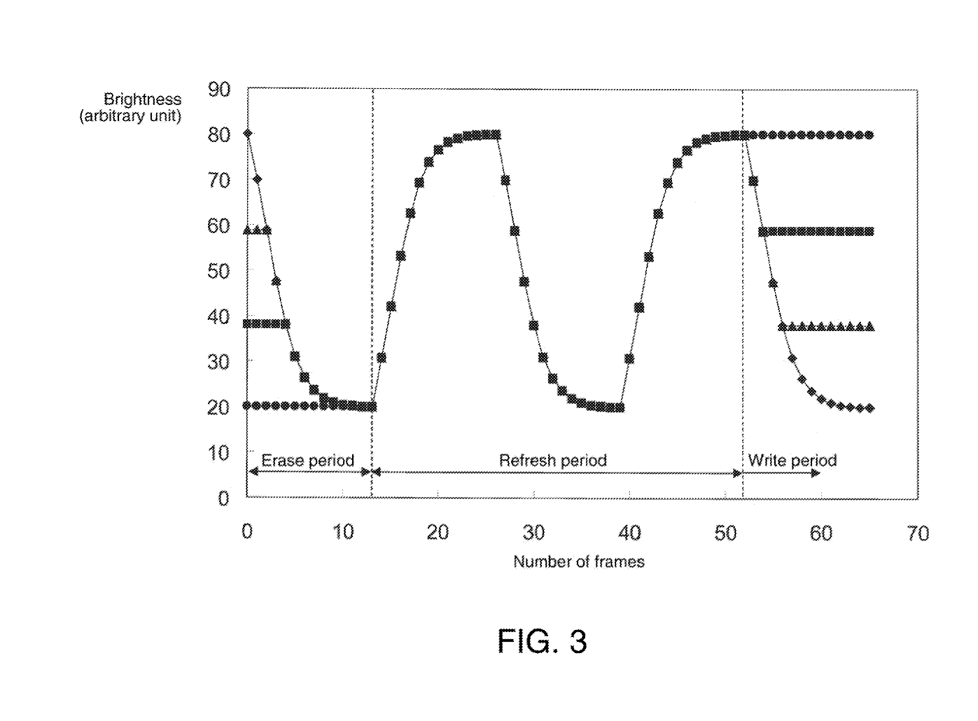

FIG. 3 is a diagram showing an example of voltage application patterns used in this embodiment. In FIG. 3, the number of frames is indicated on the horizontal axis, and the brightness of the EPD is indicated on the vertical axis. The driving of the EPD is characterised by voltage application patterns (sequences). A voltage application pattern indicates which of the first voltage (e.g., −15 V), the second voltage (e.g., +15 V), and a discharge (0 V) voltage is to be applied for a predetermined number of frames. In other words, the voltage application pattern can be said to indicate change over time in the applied voltage, and in that sense, it will be hereinafter referred to as a “drive waveform”.

There are two parameters for determining the drive waveform in this embodiment, namely the current gray level and the next gray level. The current gray level is the gray level of the EPD before rewriting. The next gray level is the gray level of the EPD after rewriting, in FIG. 3, four points are plotted at the point when the number of frames is zero, and these four points correspond to the current gray level (black, dark gray, light gray, and white). Also, the end of the drive waveform branches into four waveforms, and these branches correspond to the next gray level. For example, in the case where the current gray level is light gray and the next gray level is dark gray, the applied voltage is the discharge voltage in the 1st and 2nd frames, the second voltage in the 3rd to 12th frames, the discharge voltage in the 13th frame, the first voltage in the 14th to 25th frames, the discharge voltage in the 26th frame, the second voltage in the 27th to 38th frames, the discharge voltage in the 39th frame, the first voltage in the 40th to 51st frames, the discharge voltage in the 52nd frame, the second voltage in the 53rd to 56th frames, and the discharge voltage in the 57th to 65th frames. Once the drive waveform is determined, the voltage to be applied in each frame is determined by the frame number. Accordingly, it can be said that the voltage to be applied in each frame is determined by three parameters, namely the current, gray level, the next gray level, and the frame number.

In this embodiment, the drive waveforms are divided into an erase period (also called the erase phase or the adjustment period), a refresh period (also called the refresh phase or the reset period), and a write period (write phase). in the following description, the two gray levels that serve as references among the gray levels displayed by the EPD will be respectively referred to as the first gray level and the second gray level. Out of the first gray level and the second gray level, one corresponds to the lowest gray lever, and the other corresponds to the highest gray level. In this example, white serves as the first gray level, and black serves as the second gray level.

The erase period is a period in which the gray level of the EPD is set to a predetermined reference gray level (e.g., the second gray level, which is black). In the example shown in FIG. 3, the 1st to 13th frames correspond to the erase period. The refresh period is a period in which voltage application is performed such that a loop in which the gray level shifts from the second gray level to the first gray level and then returns to the second gray level (from black to white and then to black) is completed a predetermined number of times (at least 0.5 times). Also, in this example, the refresh period is a period for applying a voltage such that the gray level of the EPD is set to the first gray level (white) at the end of the period, in the example shown in FIG. 3, the 14th to 52nd frames correspond to the refresh period (the loop is completed 1.5 times). The write period is a period for shifting the EPD to the next gray level. In the example shown in FIG. 3, the write period is a period for shifting the EPD from the first gray level (white) to the next gray level.

In this example, the drive waveform is characterized by two parameters, namely a basic number of frames and a gray level number of frames. The basic number of frames is the number of frames necessary for causing a shift from the first gray level (white) to the second gray level (black), and from the second gray level (black) to the first gray level (white). The basic number of frames does not depend, on the next gray level, and is the same for all of the drive modes. Making the basic number of frames the same for all of the drive modes makes it possible to maintain DC balance in the EPD. In the example shown in FIG. 3, the basic number of frames is 13. Specifically, the basic number of frames is the sum of the number of frames necessary for shifting from either the first gray level or the second gray level to the other one (12 frames) and the following discharge voltage frame (one frame). The gray level number of frames is the number of frames necessary for shifting from the first gray level (white) serving as a reference to the next gray level. Although the gray level number of frames changes according to the next gray level, each gray level number of frames is the same for all of the drive modes. In the example shown in FIG. 3, the gray level number of frames is “0” when the next gray level is white, the gray level number of frames is “2” when the next gray level is light gray, the gray level number of frames is “4” when the next gray level is hark gray, and the gray level number of frames is “13” when the next gray level is black. Note that since the basic number of frames and the gray level number of frames change according to drive conditions such as the temperature, the drive waveforms are defined for each drive condition, that is to say, for each temperature zone (temperature range).

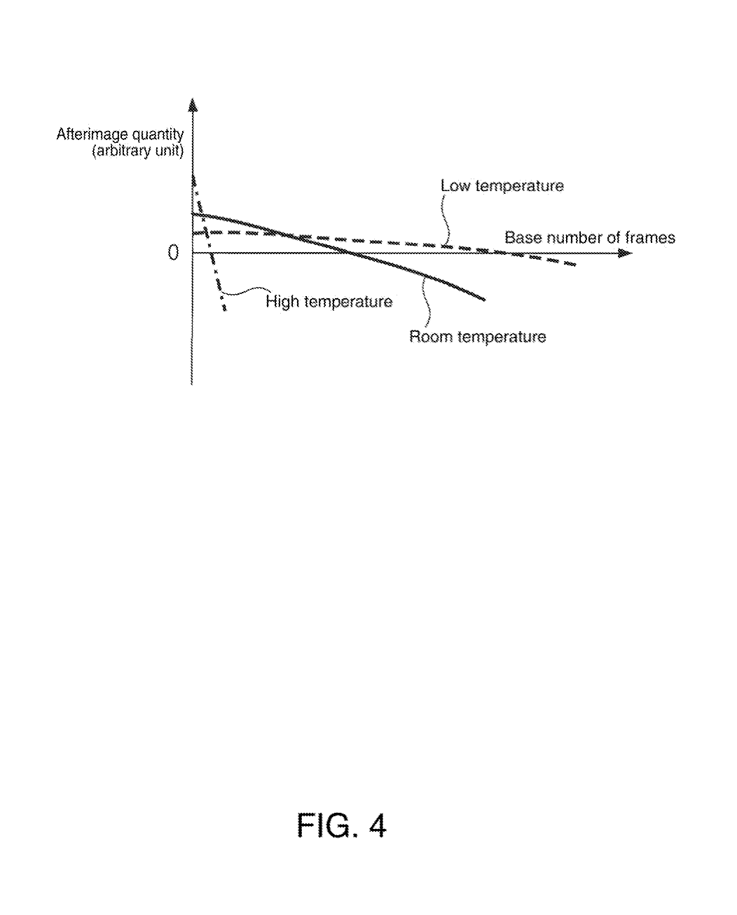

FIG. 4 is a diagram showing an example of ghost characteristics relative to the basic number of frames. The appearance of ghosts is one factor for determining the basic number of frames. In FIG. 4, the ghost quantity is indicated on the vertical axis, and the basic number of frames is indicated on the horizontal axis. FIG. 4 shows the results of measuring the ghost quantity when using certain drive waveforms (e.g., the drive waveforms shown in FIG. 3) and using the basic number of frames and the temperature as parameters.

The basic number of frames is determined so as to optimize the appearance of ghosts (i.e., ideally set the appearance of ghosts to zero). The lower the amount of change in the ghost quantity (i.e., the slope of the plotted line in FIG. 4) when changing the basic number of frames by one frame is, the easier optimisation is to perform. As is clear from FIG. 4, the slope is lowest for the low temperature, and thus the low temperature is suited, to optimization. However, the basic number of frames tends to increase for the low temperature, and this leads to the problem of a decrease in driving speed. In this embodiment, this problem is addressed not by only changing the basic number of frames and the gray level number of frames according to the temperature zone, but rather by additionally changing the number of completed loops in the refresh period according to the temperature zone.

1-2-1. LG Mode

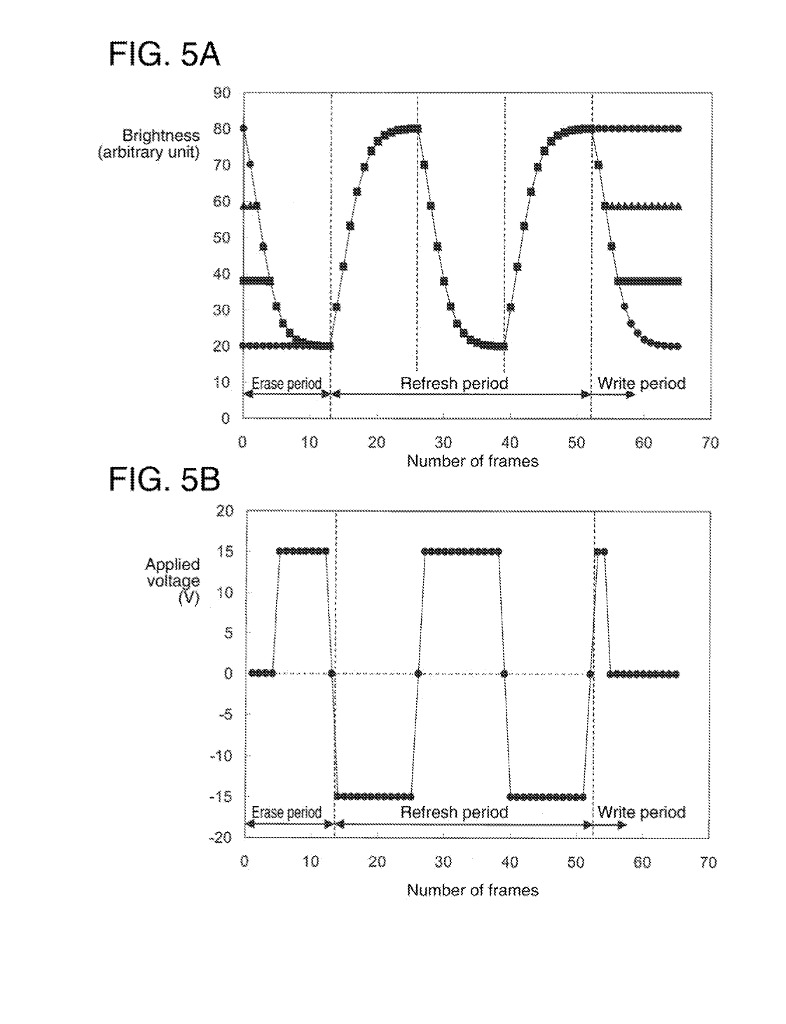

FIGS. 5A and 5B are diagrams showing examples of drive waveforms and gray level change in the LG mode. FIG. 5A shows gray level change in the LG mode. FIG. 5B shows the LG mode drive waveform in the case where the current gray level and the next gray level are dark gray and light gray respectively. The number of frames is indicated on the horizontal axis in both FIGS. 5A and 5B. The brightness of the EPD is indicated on the vertical axis in FIG. 5A. The applied voltage is indicated on the vertical axis in FIG. 5B.

In order to reduce the appearance of ghosts, the LG mode drive waveforms have a characteristic in that compared to the LF mode and the HS mode, the number of times the loop is completed in the refresh period is relatively higher, that is to say, the refresh period is longer. In the example shown in FIGS. 5A and 5B, the loop is completed 1.5 times (shift from black to white to black to white) in the refresh period. When combined with the erase period and the write period as well, the highest number of completed loops is 2.5 (when the current gray level is white and the next gray level is black), and the lowest number of completed loops is 1.5 (when the current gray level is black and the next gray level is white). In this example, the LG mode drive waveforms are defined according to the fact that the current gray level and the next gray level change between four gray levels each, and therefore 4×4=16 patterns are defined for each temperature zone.

1-2-2. LF Mode

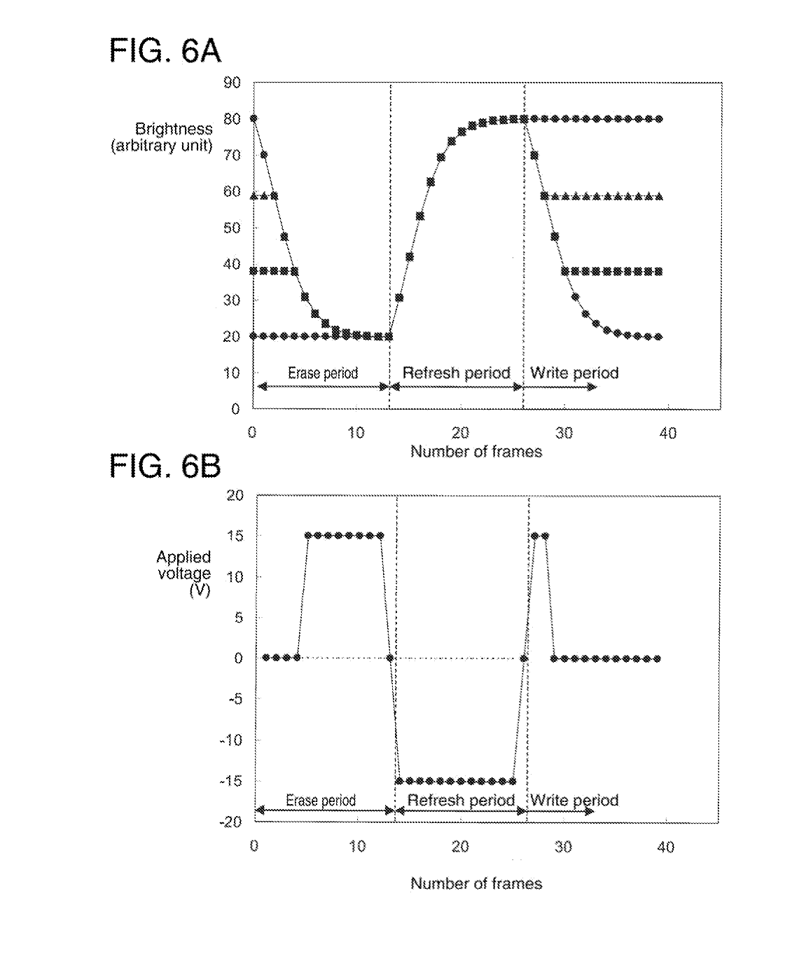

FIGS. 6A and 6B are diagrams showing examples of drive waveforms and gray level change in the LF mode. FIG. 6A shows gray level change in the LF mode. FIG. 6B shows the LF mode drive waveform in the case where the current gray level and the next gray level are dark gray and light gray respectively. The values indicated on the vertical axis and the horizontal axis are similar to those in FIGS. 5A and 5B.

In the LG mode, in order to reduce the appearance of ghosts, the loop is completed 1.5 times in the refresh period, and the highest number of completed loops over all of the periods is 2.3. This means that flashing (repeated gray level change between black and white) will be performed at a speed at which the flashing is perceptible to the user. Flashing is nothing but visual noise to the user. In view of this, the LF mode drive waveforms have a characteristic in that the number of completed loops is lower than in the LG mode in order to reduce the occurrence of flashing. In the example shown in FIGS. 6A and 6B, the loop is completed 0.5 times (shift from black to white) in the refresh period. When combined with the erase period and the write period as well, the highest number of completed loops is 1.5 (when the current gray level is white and the next gray level is black), and the lowest number of completed loops is 0.5 (when the current gray level is black and the next gray level is white). In this example, the LF mode drive waveforms are defined according to the fact that the current gray level and the next gray level change between four gray levels each, and therefore 4×4=16 patterns are defined for each temperature zone.

1-2-3. HS Mode

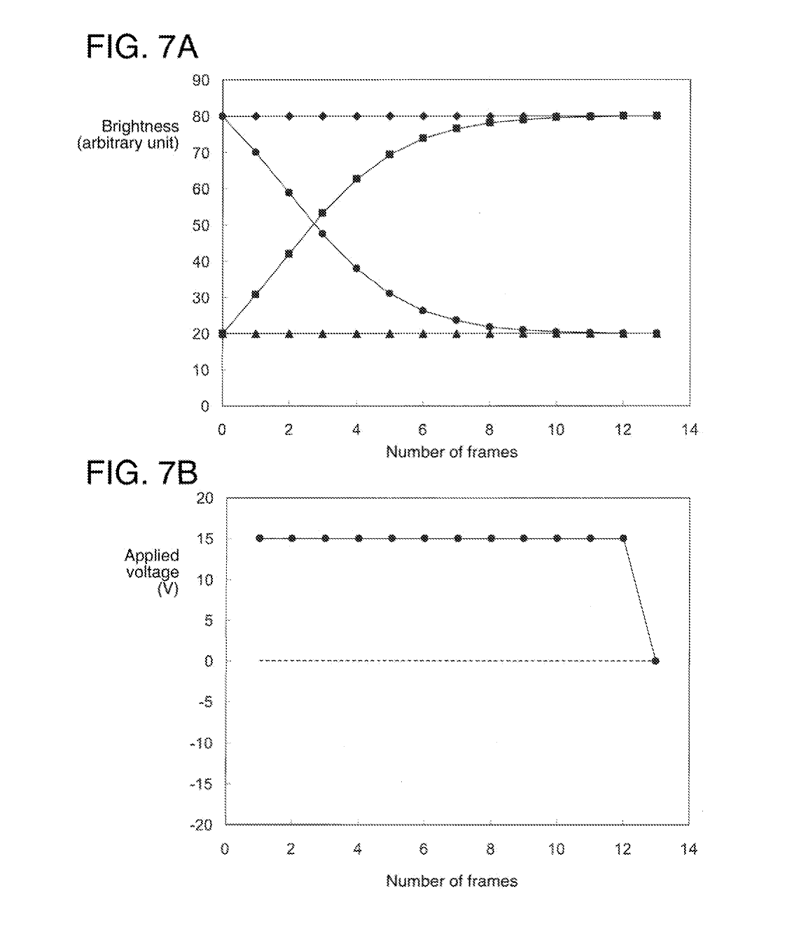

FIGS. 7A and 7B are diagrams showing examples of drive waveforms and gray level change in. the HS mode. FIG. 7A shows gray level change in the HS mode. FIG. 7B shows the HS mode drive waveform in the case where the current gray level and the next gray level are white and black respectively. The values indicated on the vertical axis and the horizontal axis are similar to those in FIGS. 5A and 5B and FIGS. 6A and 8B.

Although the number of completed loops is lower in the LF mode than in the LG mode, the highest number of completed loops is 1.5, and there is room for improvement in terms of rewriting speed. In view of this, the HS mode has a characteristic in that, the number of gray levels to be displayed is limited to two gray levels (black and white) in order to increase the speed of rewriting, and rewriting is performed by direct shift between these two gray levels. Direct shift refers to shifting that corresponds to the loop being completed 0.5 times. Also, the HS mode drive waveforms only have the write period, that is to say, do not have the erase period or the refresh period. Over the entirety of the HS mode drive waveforms, the loop is completed 0.5 times in shifts to a different gray level. If the current gray level and the next gray level are the same, the loop is not performed. In this example, the HS mode drive waveforms are defined according to the fact that the current gray level, and the next gray level change between two gray levels each, and therefore 2*2=4 patterns are defined for each temperature zone,

2. Configuration

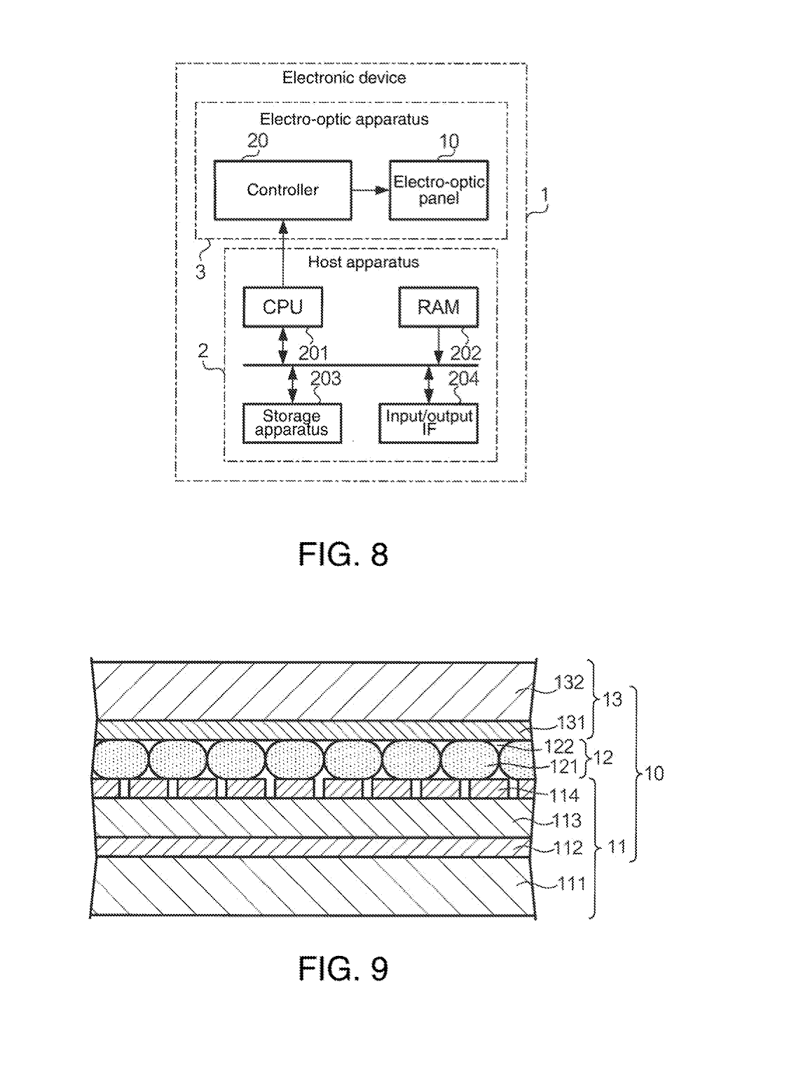

FIG. 8 is a diagram showing the configuration of an electronic device 1 according to an embodiment. The electronic device 1 has a host apparatus 2 and an electro-optic apparatus 3. The electro-optic apparatus 3 is an apparatus for displaying images under control of the host apparatus 2, and it has an electro-optic panel 10 and a controller 20. In this example, the electro-optic panel 10 has a. display element that, employs electrophoretic particles, as a memory display element that holds its display even if energy is not applied through voltage application or the like. Kith this display element, the electro-optic panel 10 displays images having multiple monochrome gray levels (in this example, the four gray levels black, dark gray, light gray, and white). The controller 20 is a control apparatus that controls the electro-optic panel 10. The host apparatus 2 is an apparatus that controls the electro-optic apparatus 3, and it has a CPU (Central Processing Unit) 201, a RAM (Random Access Memory) 202, a storage apparatus 203, and an input/output interface 204. The CPU 201 executes programs stored in a ROM (Read Only Memory, not shown) or the storage apparatus 203, using the RAM 202 as a work area. The RAM 202 is a volatile memory for storing data. The storage apparatus 203 is a storage apparatus for storing various types of data and application programs, and it has a nonvolatile memory such as a flash memory. The input/output interface 204 is an interface for the input and output of data with various types of input apparatuses and an output apparatus such as the electro-optic apparatus 3. The electronic device 1 is an e-book reader, a measuring device, an electronic Point-of-Purchase apparatus, or the like.

FIG. 9 is a schematic diagram showing the cross-sectional structure of the electro-optic panel 10. The electro-optic panel 10 has a first substrate 11, an electrophoretic layer 12, and a second substrate 13. The first substrata 11 and the second substrate 13 are substrates for sandwiching the electrophoretic layer 12.

The first substrate 11 has a substrate 111, an adhesive layer 112, and a circuit layer 113. The substrate 111 is formed from, a material that is insulating and flexible, such as polycarbonate. The substrate 111 may be formed from a resin material other than polycarbonate as long as it is light-weight, flexible, elastic, and insulating. As. an alternative example, the substrate 111 may be formed from glass, which is not flexible. The adhesive layer 112 is a layer for adhering the substrate 111 and the circuit layer 113 to each other. The circuit layer 113 is a layer that has circuitry for driving the electrophoretic layer 12. The circuit layer 113 has pixel electrodes 114.

The electrophoretic layer 12 has microcapsules 121 and a binder 122. The microcapsules 121 are fixed by the binder 122. A material that has favorable affinity with the microcapsules 121, has superior adhesion with electrodes, and is insulating is used as the binder 122. The microcapsules 121 are capsules that internally hold a disperse medium sub electrophoretic particles. A flexible material is used to form the microcapsules 121, such as a gum Arabic-based or gelatin-base compound, or a urethane-based compound. Note that an adhesive layer formed from an adhesive agent may foe provided between the microcapsules 121 and the pixel electrodes 114.

The electrophoretic particles are particles (molecules or colloids) that have the characteristic of moving in a disperse medium due to an electrical field. In this embodiment, white electrophoretic particles and black electrophoretic particles are held inside the microcapsules 121. Black electrophoretic particles are particles that include a black pigment such as aniline black or carbon black, and are positively charged in this embodiment. The white electrophoretic particles are particles that include a white pigment such as titanium dioxide or aluminum oxide, and are negatively charged in this embodiment.

The second substrate 13 has a common electrode 131 and a film 132. The film 132 is for sealing and protecting the electrophoretic layer 12. The film 132 is formed from a material that is transparent and insulating, such as polyethylene terephthalate. The common electrode 131 is formed from, a material that is transparent and is conductive, such as ITO (Indium Tin Oxide).

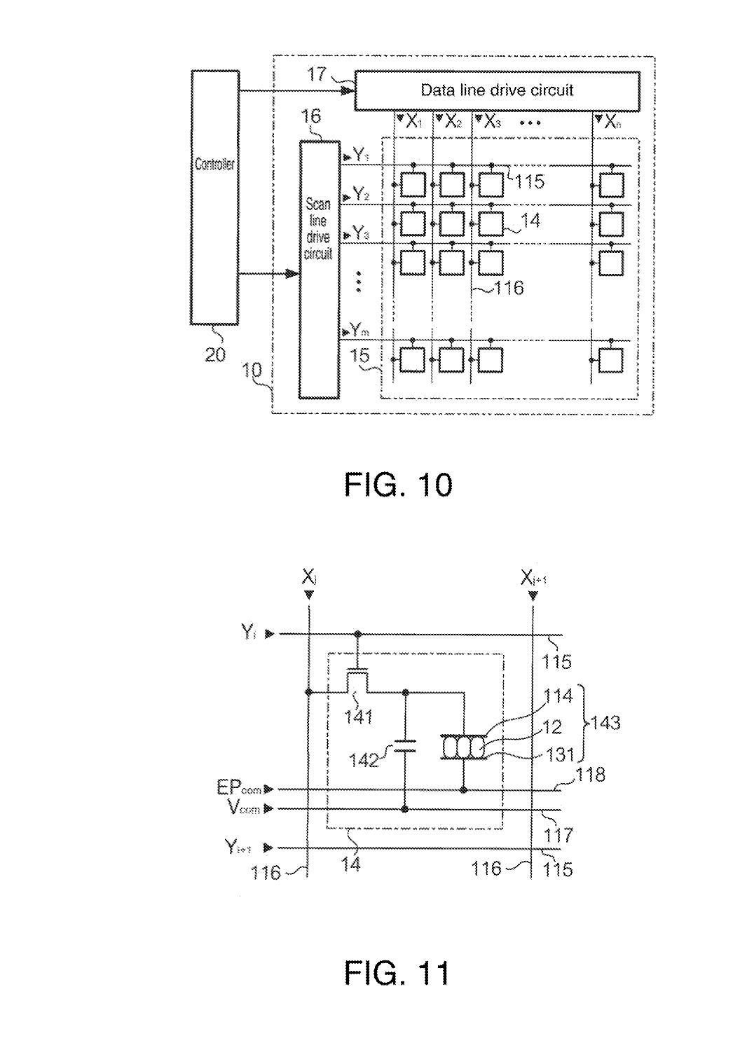

FIG. 10 is a diagram showing the circuit configuration of the electro-optic panel 10. The electro-optic panel 10 has m scan lines 115, n data lines 116, m×n pixels 14, a scan line drive circuit 16, and a data line drive circuit 17. The scan line drive circuit 16 and the data line drive circuit 17 are controlled by the controller 20. The scan lines 115 are arranged along the row direction (x direction.), and transmit scan signals. The scan signal is a signal for successively exclusively selecting one scan line 115 from among the m scan lines 115. The data lines 116 are arranged along the column direction (y direction), and transmit data signals. The data signal is a signal indicating the gray levels or pixels. The scan lines 115 and the data lines 116 are insulated. A pixel 14 is provided at each intersection between a scan line 115 and a data line 116, and it displays a gray level in accordance with a data signal. Note that the notation 1st row, 2nd row, . . . , m-th row scan line 115 will be used when there is a need to identify one scan line 115 from among the scan lines 115. The same follows for the data lines 116 as well. A display region 15 is formed by the m×n pixels 14. The notation pixel (j,i) will be used when distinguishing the pixel 14 in the i-th row and j-th column from the other pixels 14 in the display region 15. The same follows for the other parameters that are in one-to-one correspondence with the pixels 14, such as the gray level value.

The scan line drive circuit 16 outputs a scan signal Y for successively exclusively selecting one scan line 115 from, among the m scan lines 115. The scan signal Y is a signal that is successively exclusively at the H (High) level for one scan line. The data line drive circuit 17 outputs a data signal X. The data signal X is a signal indicating data voltages that correspond to the gray level values of pixels. The data line drive circuit 17 outputs data signals indicating data voltages that correspond to the pixels in the row selected by the scan signal. The scan line drive circuit 16 and the data line drive circuit 17 are controlled by the controller 20.

FIG. 11 is an equivalent circuit diagram of one pixel 14. The pixel 14 has a transistor 141, a capacitor 142, and an electrophoretic element 143. The electrophoretic element 143 has a pixel electrode 114, an electrophoretic layer 12, and a common electrode 131. The transistor 141 is one example of a switching unit that controls the writing of data to the pixel electrode 114, and it is an n-channel TFT (Thin Film Transistor), for example. The gate, source, and drain of the transistor 141 are respectively connected to one scan line 115, one data line 116, and the pixel electrode 114. If a scan signal at the L (Low) level (unselected signal) is input to the gate, the source and the drain of the transistor 141 are insulated. If a scan signal at the H level (selected signal) is input to the gate, the source and the drain of the transistor 141 are put into a conductive state, and a data voltage is written to the pixel electrode 114. Also, one electrode of the capacitor 142 is connected to the drain of the transistor 141, and the other electrode of the capacitor 142 is connected to a reference potential Vcom via a line 117. The capacitor 142 holds a charge that corresponds to the data voltage. One pixel electrode 114 is provided in each pixel 14, and the pixel electrode 114 opposes the common electrode 131. The common electrode 131 is provided so as to be common to all of the pixels 14, and a potential EPcom is applied to the common electrode 131 via a line 118. The electrophoretic layer 12 is sandwiched between the pixel electrode 114 and the common electrode 131. The electrophoretic element 143 is formed by the pixel electrode 114, the electrophoretic layer 12, and the common electrode 131. A voltage that corresponds to the potential difference between the pixel electrode 114 and the common electrode 131 is applied to the electrophoretic layer 12. A gray level is expressed due to the movement of the electrophoretic particles in the microcapsules 121 in accordance with the voltage applied to the electrophoretic layer 12. if the potential of the pixel electrode 114 is positive (e.g., +15 V) relative to the potential EPcom of the common electrode 131, the negatively charged white electrophoretic particles move to the pixel electrode 114 side, and the positively charged black electrophoretic particles move to the common electrode 131 side. When the electro-optic panel 10 is viewed from the second substrate 13 side at this time, the pixel appears to be black. If the potential of the pixel electrode 114 is negative (e.g., −15 V) relative to the potential EPcom of the common electrode 131, the positively charged black electrophoretic particles move to the pixel electrode 114 side, and the negatively charged white electrophoretic particles move to the common electrode 131 side. The pixel appears white at this time.

Note that in the following description, “frame” refers to the period from when the scan line drive circuit 16 selects the 1st row scan line until when the selection of the m-th row scan line ends. The scan lines 115 are selected one time each in one frame, and the data signal is supplied to the pixels 14 one time each in one frame.

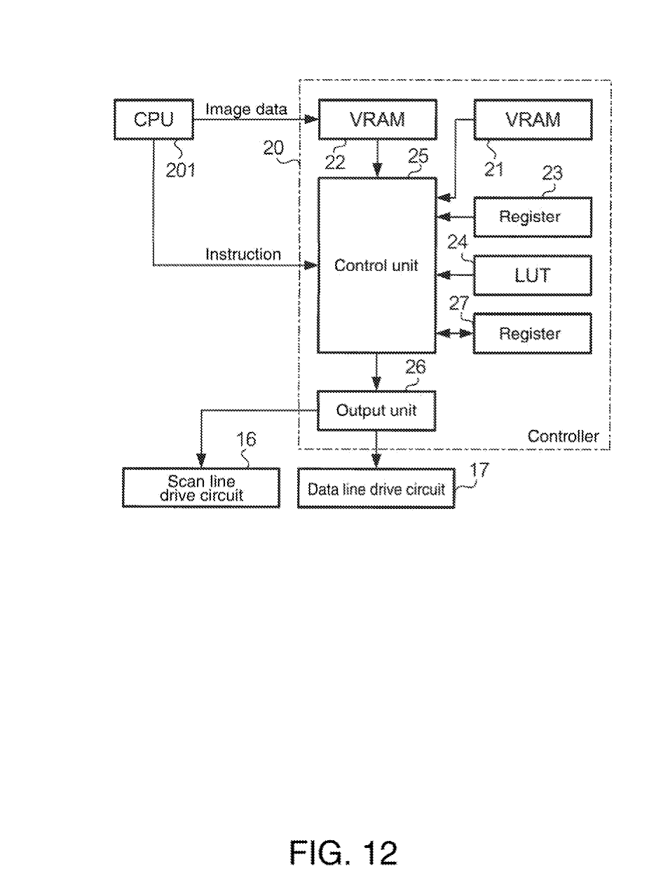

FIG. 12 is a diagram showing an example of the configuration of the controller 20. The controller 20 has a VRAM 21, a VRAM 22, a register 23, an LUT 24, a control unit 25, an output unit 26, and a register 27. The VRAM 21 is a memory for storing the image chat is being displayed on the electro-optic panel 10 before rewriting. Specifically, the VRAM 21 stores data indicating the current gray levels of each of the pixels 14 in the m rows and n columns. The VRAM 22 is a memory for storing the image that is to be displayed on the electro-optic panel 10 after rewriting. Specifically, the VRAM 22 stores data indicating the next gray levels of each of the pixels 14 in the m rows and n columns. The register 23 is a register that stores a parameter for specifying the frame number, that is to say, is a frame number counter. The LUT 24 is a table storing information for specifying voltages to be applied in each frame. In this example, the LUT 24 includes unique tables for the LG mode, the LF mode, and the HS mode respectively.

Also, in this example, the LUT 24 includes unique tables for multiple temperature zones. For example, the LUT 24 includes unique tables for three temperature zones, namely a low-temperature (0 to 15° C.), a room-temperature (15 to 30*0, and a high-temperature (30 to 45° C.) zone, for each drive mode. These tables are all designed based on the ideas described above. The basic number of frames and the gray level number of frames are set for each temperature zone.

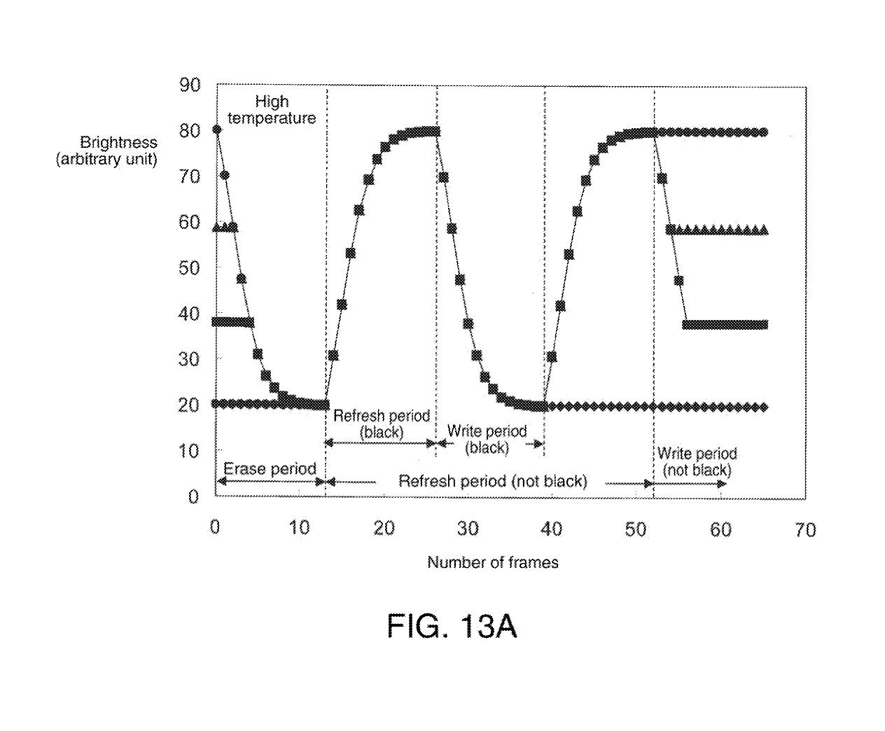

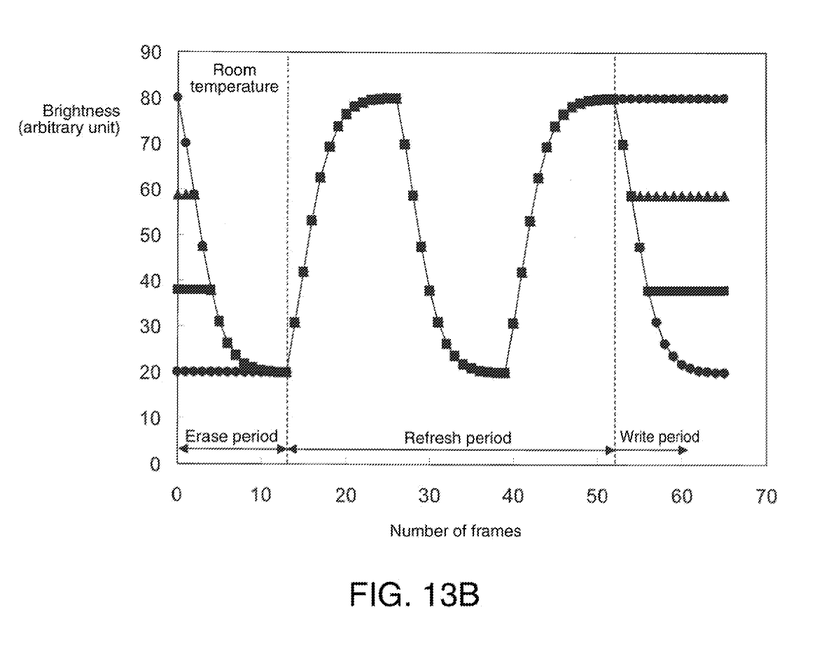

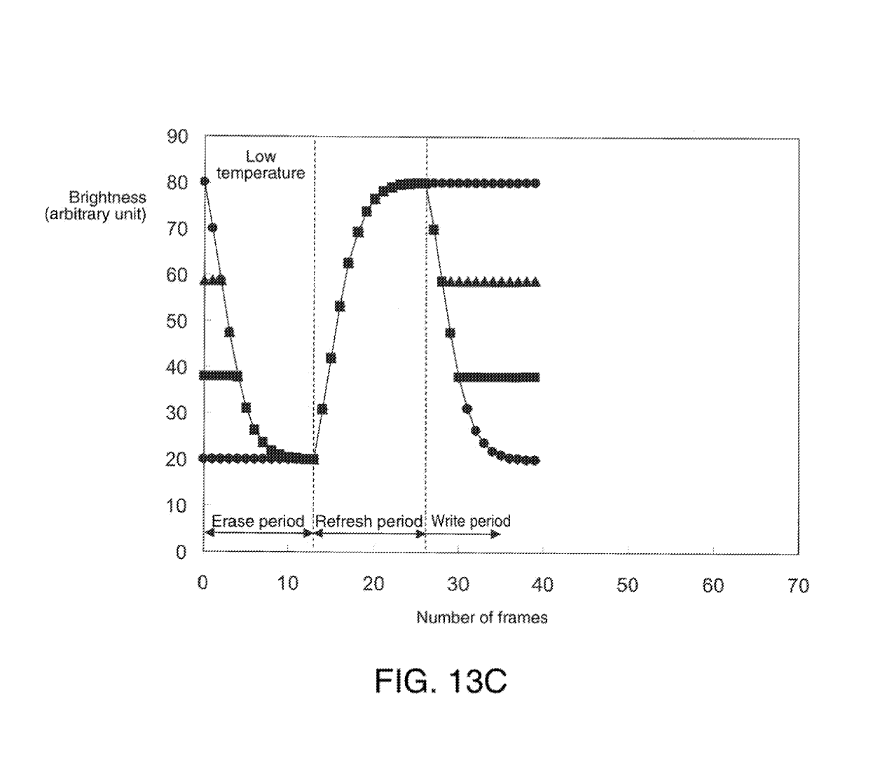

FIGS. 13A to 13C are diagrams showing an example of drive waveforms for each temperature zone. FIGS. 13A to 13C show drive waveforms used in rewriting from a certain current gray level (e.g., black) to a certain next gray level (e.g., light gray) in a certain drive mode (e.g., the LG mode). FIG. 13A shows high-temperature drive waveforms. FIG. 133 shows room-temperature drive waveforms, and FIG. 13C shows low-temperature drive waveforms. Although the basic number of frames is set for each temperature zone as previously described, for the sake of simplicity, the following description is given taking the example where the basic number of frames is the same in all of the temperature zones.

A comparison of the high-temperature drive waveforms and the room-temperature drive waveforms shows that the two are the same except for the drive waveforms for when the next gray level is black, and thus are only different with respect to the drive waveforms for when the next gray level is black. In the high-temperature drive waveform for when the next gray level is black, the loop is completed 1.5 times in the refresh period, and in the room-temperature drive waveform, the loop is completed 0.5 times in the refresh period. In the high-temperature drive waveforms other than for when the next gray level is black, the loop is completed 1.5 times in the refresh period, and in the room-temperature drive waveforms, the loop is completed 1.5 times in the refresh period. In other words, a comparison of the high-temperature drive waveforms and the room-temperature drive waveforms shows that the number of completed loops in the refresh period, in the high-temperature drive waveforms is higher than or equal to that in the room-temperature drive waveforms regardless of the current gray level or the next gray level.

A comparison of the room-temperature drive waveforms and the low-temperature drive waveforms shows that the two are the same with respect to the drive waveform for when the next gray level is black, and are different with respect to the drive waveforms for when the next gray level is the other three gray levels. In the room-temperature drive waveform for when the next gray level is black, the loop is completed 0.5 times in the refresh period, and in the low-temperature drive waveform, the loop is completed 0.5 times in the refresh period. In the room-temperature drive waveforms other than for when the next gray level is black, the loop is completed 1.5 times in the refresh period, and in the low-temperature drive waveforms, the loop is completed 0.5 times in the refresh period. In other words, a comparison of the room-temperature drive waveforms and the low-temperature drive waveforms shows that the number of completed loops in the refresh period in the room-temperature drive waveforms is higher than or equal to that in the low-temperature drive waveforms regardless of the current gray level or the next gray level. In other words, in all three of the temperature zones, the number of completed loops in the refresh period in the drive waveforms for a higher temperature zone is higher than or equal to that in the drive waveforms for a lower temperature cone regardless of the current gray level or the next gray level. Note that this magnitude relationship between the number of completed loops holds not only for the LG mode, but also for the LF mode drive waveforms.

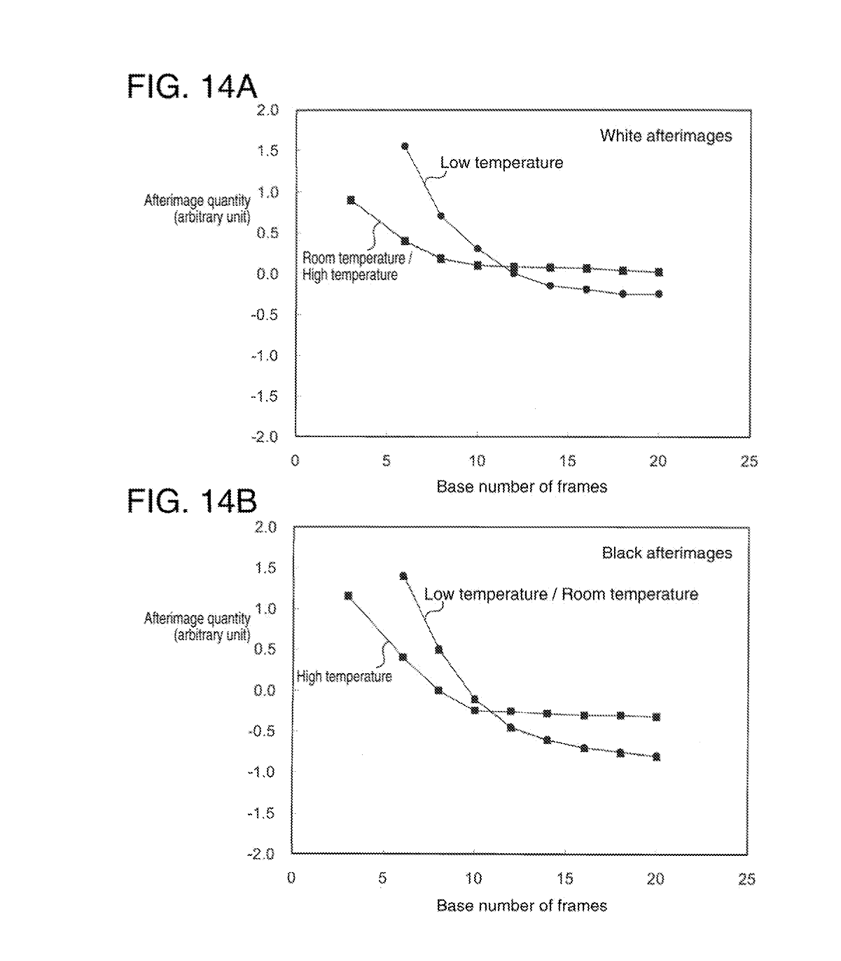

FIGS. 14A and 14B are diagrams showing examples of an ghost characteristic when using the drive waveforms in FIGS. 13A to 13C. FIG. 14A snows a white ghost characteristic, and FIG. 14B shows a black ghost characteristic. Note that although drive waveforms for the respective temperature zones were used, ghost measurement was performed at a constant temperature (room temperature). An ghost quantity is indicated on the vertical axis, and the basic number of frames is indicated on the horizontal axis. The ghost quantity for white ghosts is defined as the difference in brightness between the group of pixels rewritten from black to white and the group of pixels that remain white and were not rewritten. The ghost quantity for black ghosts is defined as the difference in brightness between the group of pixels rewritten from white to black and the group of pixels that remain black and were not rewritten.

For both white ghosts and black ghosts, there was greater improvement in terms of ghosts with the drive waveforms for the higher temperature zone (i.e., the drive waveforms with the higher number of completed loops). Note that when the next gray level is white, the high-temperature drive waveform (FIG. 13A) and the room-temperature drive waveform (FIG. 13B) are the same, and therefore the ghost characteristic for white ghosts is the same for both of them. Similarly, when the next gray level is black, the room-temperature drive waveform (FIG. 13B) and the low-temperature drive waveform (FIG. 13C) are the same, and therefore the ghost characteristic for black ghosts is the same for both of them.

As was described with reference to FIG. 4, the precision is poor for the optimization of ghosts through base frame adjustment in the high-temperature drive waveforms, but since the number of completed loops is high in the refresh period, there is greater improvement in terms of ghosts in comparison to the case where the number of completed loops in the refresh period is the same for all of the temperature zones.

Also, as was described with reference to FIG. 4, the optimization of ghosts through base frame adjustment is easy in the low-temper at are drive waveforms. In other words, in the law-temperature drive waveforms, ghosts can be suppressed through base frame adjustment rather than the adjustment of the number of completed loops in the refresh period. Accordingly, the optimisation of ghosts is performed through base frame adjustment, and as shown in FIG. 13C, the number of completed loops in the refresh period can be set relatively lower than that in the room-temperature and high-temperature drive waveforms. This enables shortening the drive time in low-temperature driving.

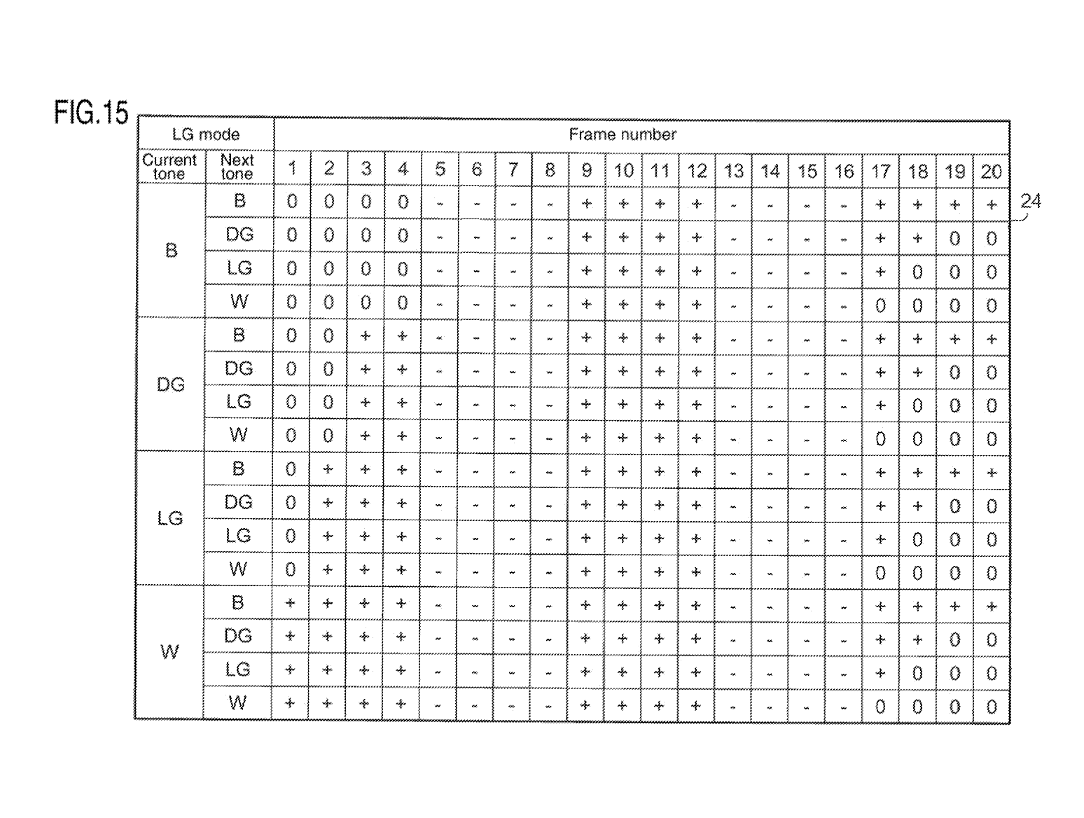

FIG. 15 is a diagram showing an example of a table (one of multiple tables) stored in the LUT 24. Each table includes data indicating current gray levels and next gray levels, as well applied voltage patterns corresponding to the current gray levels and the next gray levels. In this table, black, dark gray, light gray, and white are respectively indicated as B, DG, LG, and W. In this example, the applied voltage is one of “+”, “0”, and “−”. Here, “+” and “−” respectively indicate that a positive voltage (the second voltage) and a negative voltage (the first voltage) are to be applied, and “0” indicates that discharging is to be performed. The table shown as an example in FIG. 15 is, among the tables stored in the LUT 24, a table indicating LG mode drive waveforms at a certain temperature. In this example, the basic number of frames is “4”, and the gray level number of frames is “4” for black, “2” for dark gray, for light gray, and “0” for white. For example, when the current gray level and the next gray level are respectively dark gray and light gray in the LG mode, the total n timber of frames is 17 frames. Among these frames, the 1st to 4th frames correspond to the erase period, the 5th to 16th frames correspond to the refresh period, and the 17th frame corresponds to the write period. Discharge is performed in the 1st and 2nd frames, and a positive voltage is applied in the 3rd and 4th frames. A voltage for completing the loop 1.5 times is applied in the 5th to 16th frames. A positive voltage is applied in the 17th frame, and the gray level of the EPD ultimately shifts to light gray. Note that a frame for discharging all of the pixels at once is not provided in the examples shown in FIGS. 13A to 13C. In this way, the discharge frame can be omitted. Of course, a discharge frame similar to that in the examples shown in FIGS. 5A and 5B may be provided in FIGS. 13A to 13C. Hereinafter, the data indicating applied voltages in the frames will be referred to as “voltage data”.

The following description returns to FIG. 12. The control unit 25 generates signals for controlling the electro-optic panel 10. More specifically, the control unit 25 reads out voltage data that corresponds to the drive mode, the current gray level, the next gray level, and the frame number from the LUT 24. The control unit 25 then generates a signal that corresponds to the voltage data that was read out. The cutout unit 26 then outputs the signal that was generated by the control unit 25. The register 27 then stores an identifier for specifying the drive mode that is to be applied to image rewriting from among the drive modes with which the controller 20 is provided.

The control unit 25 is an example of an acquisition unit that acquires image data that indicates an image to be displayed on a memory display element (the electro-optic panel 10), and a control unit that controls drive circuits (the scan line drive circuit 16 and the data line drive circuit 17) for driving the memory display element such that voltages that correspond to the image data are applied to the memory display element.

3. Operations

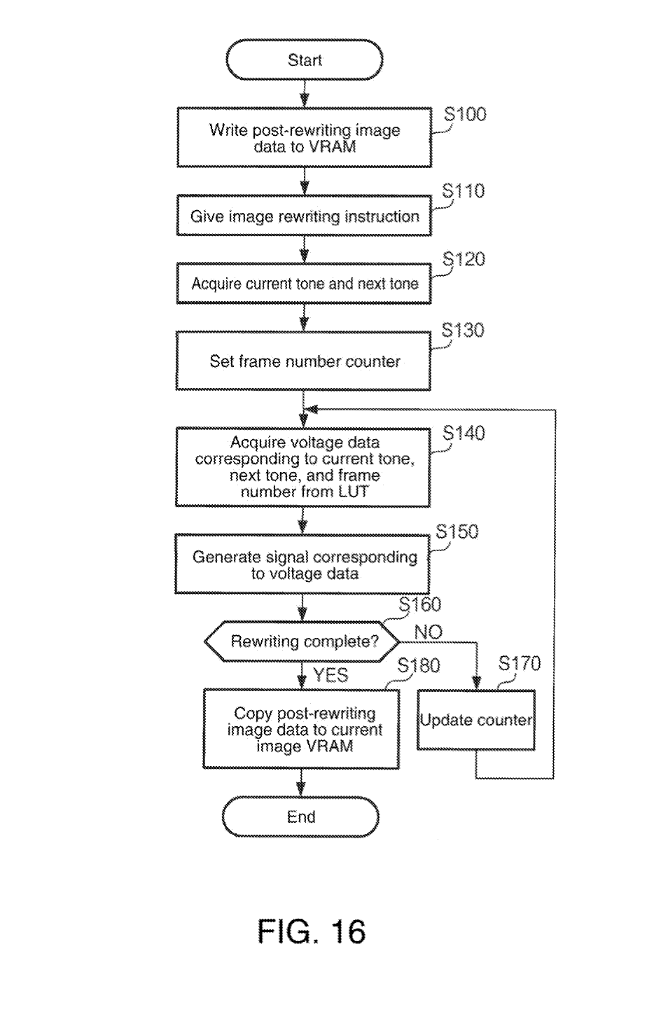

FIG. 16 is a flowchart showing operations in one embodiment of the electronic device 1. In the electronic, device 1, the processing flow in FIG. 16 is started when the CPU 201 executes a program and furthermore a predetermined event has occurred in the execution of the program.

In step S100, the CPU 201 of the host apparatus 2 writes image data that indicates the image after rewriting to the VRAM 22. In step S110, the CPU 201 instructs the controller 20 to perform image rewriting. This instruction includes an identifier that specifies, from among the drive modes with which the controller 20 is provided, the drive mode that is to be applied to image rewriting at this time.

Upon receiving the instruction to perform image rewriting, the control unit 25 of the controller 20 writes the identifier for the drive mode that is to be applied to the register 27. In step S120, the control unit 25 acquires data indicating pre-rewriting gray level values (current gray levels) and post-rewriting gray level values (next gray levels) for the pixels targeted for rewriting from the VRAM 21 and the VRAM 22 respectively. In step S130, the control unit 25 sets the number of frames counter. Specifically, the total number of frames corresponding to the drive waveform that is to be applied to rewriting at this time is written to the register 23. The total number of frames corresponding to the drive waveform is acquired from the LUT 24, for example.

Note that if the drive mode that is to be applied is the HS mode, elementary color processing for conversion from four gray levels to two gray levels is performed on the data indicating the post-rewriting image stored in the VRAM 22.

In step S140, the control unit 25 reads out the voltage data that corresponds to the current gray level, the next gray level, and the frame number from the LUT 24. In step S150, the control unit 25 generates a signal that corresponds to the voltage data that was read out. The output unit 26 then outputs the signal that was generated by the control unit 25.

In step S160, the control unit 25 determines whether image rewriting has been completed. The determination of whether or not image rewriting has been completed is made using the counter value stored in the register 23. Specifically, if the counter value stored in the register 23 is zero, the control, unit 25 determines that image rewriting has been completed. In the case of determining that image rewriting has been completed (step S160: YES), the control unit 25 moves to the processing of step S180. in the case of determining that image rewriting has not been completed (step S160: NO), the control unit 25 moves to the processing of step S170.

In step S170, the control unit 25 updates the counter value stored in the register 23. Specifically, the control unit 25 decrements the counter value stored in the register 23. After updating the counter value, the control unit 25 moves to the processing of step S140.

In step S180, the control unit 25 copies the data stored in the VRAM 22 to the VRAM 21. In this way, the image being displayed on the electro-optic panel 10 and the data being stored in the VRAM 21 conform to each other. When the data copying ends, the control unit 25 ends the processing of the flowchart in FIG. 16. Note that although processing for updating the processing target pixel has not been described here, the processing of steps S120 to S180 is performed for all of the pixels that are to be rewritten.

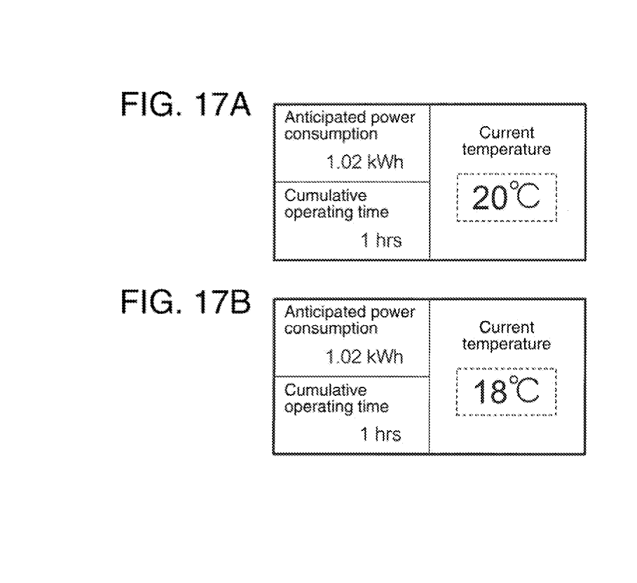

FIGS. 17A and 17B are diagrams showing examples of images displayed on the electro-optic panel 10. In this example, information regarding the usage state of the electronic device 1 is displayed on the electro-optic panel 10. The information regarding the usage state includes the anticipated power consumption, the cumulative operating time, and the temperature. Among these, the temperature changes relatively more frequently, and the anticipated power consumption and the cumulative operating time change relatively less frequently. Accordingly, the CPU 201 of the host apparatus 2 instructs the controller 20 such that only the region in which the temperature is displayed (the region enclosed by broken lines in the figures) is rewritten in the HS mode. FIG. 17A shows the pre-rewriting image, and FIG. 17B snows the post-rewriting image. When a predetermined event occurs, such as when the entirety of the screen illustrated in FIGS. 17A and 17B is to be rewritten so as to display a different image, the CPU 201 instructs the controller 20 such that rewriting is performed in the LG mode or the LF mode.

4. Variations

This invention is not intended to be limited to the embodiment described above, and can foe carried out with various modifications. Several variations will be described below. Two or more of the following variations may be used in combination with each other.

4-1. Variation 1

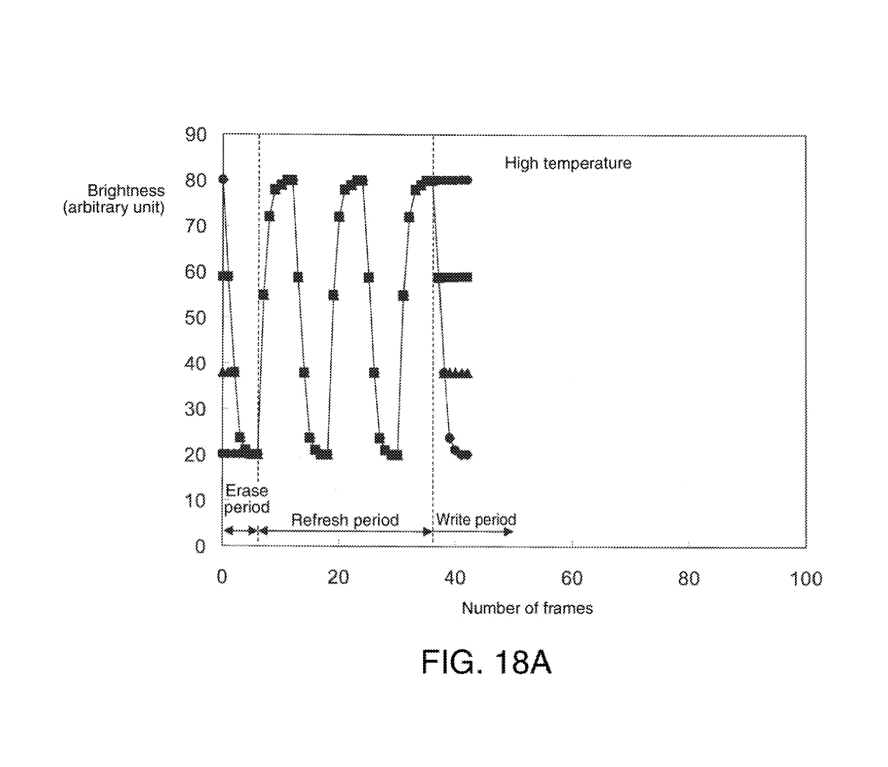

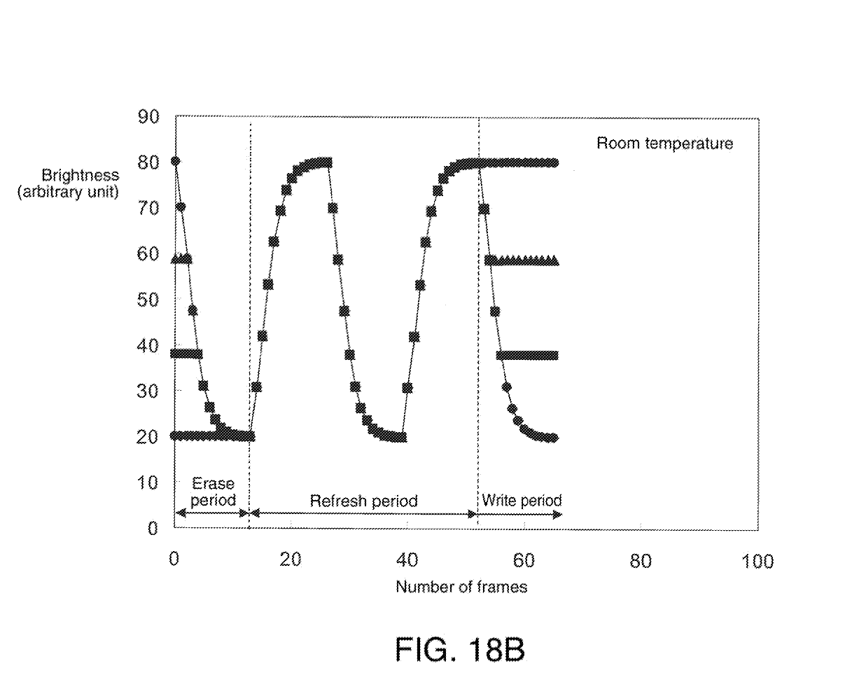

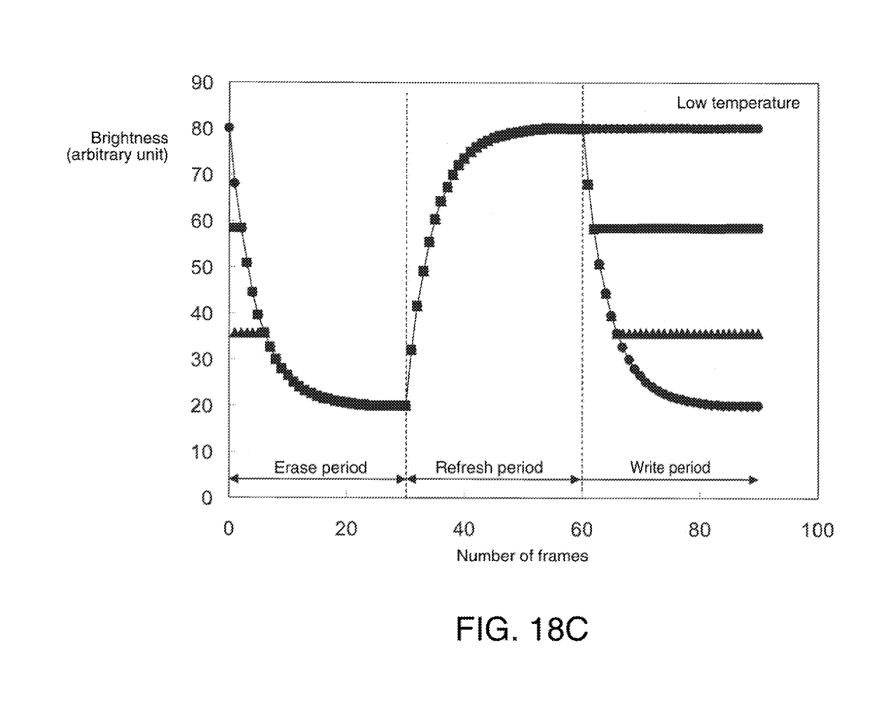

FIGS. 18A to 18C are diagrams showing an example of drive waveforms according to Variation 1. In the drive waveforms illustrated in FIGS. 13A to 13C, the number of completed loops is the same in a portion of the drive waveforms for multiple temperature zones. For example, a comparison of the high-temperature drive waveforms and the room-temperature drive waveforms shows that the number of completed loops is the same in the cases other than when the next gray level is black. However, a configuration is possible in which, as shown in FIGS. 18A to 18C, the number of completed loops is different in different temperature zones in all of the drive waveforms (i.e., regardless of the next gray level). FIG. 18A shows high-temperature drive waveforms, FIG. 18B shows room-temperature drive waveforms, and FIG. 18C shows low-temperature drive waveforms. Note that in this example, the basic number of frames is different for each temperature zone; specifically, the basic number of frames in the high-temperature drive waveforms is “6”, the basic number of frames in the room-temperature drive waveforms is “13”, and the basic number of frames in the low-temperature drive waveforms is “30”.

4-2. Variation 2

In the above-described embodiment, the number of completed loops changes according to the temperature zone in the drive waveforms for both the LG mode and the LF mode. However, a configuration is possible in which the number of completed loops changes according to the temperature zone in either one of these modes (e.g., in only the LG mode).

4-3. Variation 3

The number of drive modes that the controller 20 is provided with is not limited to three. The controller 20 need only be provided with at least one of the LG mode and the LF mode described in the embodiment. Also, another drive mode may be added in addition to the three drive modes described in the embodiment.

4-4. Variation 4

The gray level of the EPD at the end of the erase period is not limited to being the second gray level (black in the embodiment). The erase period may be a period in which the gray level of the EPD is set to the first gray level.

4-5. Variation 5

The numbers of completed loops described in the embodiment for the LG mode and the LF mode are merely examples, and the numbers of completed loops are not limited to these numbers. The number of completed loops in the LF mode need only be at least “0.5”, and may be any number greater than or equal to this.

4-6. Variation 6

Although the embodiment describes an example in which the basic number of frames and the gray level number of frames are the same in all of the drive modes, a configuration is possible in which at least one of the basic number of frames and the gray level number of frames is defined for each drive mode.

4-7. Variation 7

Although the embodiment describes an example in which the first gray level is white and the second gray level is black, the first gray level and the second gray level are not limited to these colors. In this case, it is preferable that the shift from the first gray level to the second gray level is slower than the shift from the second gray level to the first gray level (the response speed is slower). The embodiment describes an example in which an intermediate gray level is expressed using a shift from the first gray level (white) to the second gray level (black) in the write period. Expressing gray levels using shifting that has a slow response speed enables expressing intermediate gray levels with higher precision.

4-8. Variation 8

The configuration of the controller 20 is not limited to the configuration illustrated in FIG. 12. For example, a configuration is possible in which the VRAM 21 and the VRAM 22 are not provided in the controller 20, but rather the VRAM 21 and the VRAM 22 are provided externally to the controller 20. The same follows for the LUT 24, the register 23, and the register 27.

4-9. Other Variations

The equivalent circuit of the pixel 14 is not limited to the description given in the embodiment. Switching elements and capacitor elements may be combined in any way as long as the configuration is able to apply controlled voltages between the pixel electrode 114 and the common electrode 131. Also, the method of driving the pixel may be either bipolar driving in which there are electrophoretic elements 143 having different applied voltage polarities in a single frame, or unipolar driving in which voltages of the same polarity are applied to all of the electrophoretic elements 143 in a single frame.

The structure of the pixel 14 is not limited to the description given in the embodiment. For example, the polarities of the charged particles are not limited to the description given in the embodiment. The black electrophoretic particle may be negatively charged, and the white electrophoretic particles may be positively charged. In this case, the polarities of the voltages applied to the pixel are the opposite of the polarities described in the embodiment. Also, the display element is not limited to being an electrophoretic display element that employs microcapsules. Another display element may be used, such as a liquid, crystal element or an organic EL (Electro Luminescence) element.

The parameters described in the embodiment (e.g., the number of gray levels, the number of pixels, the voltage values, and the number of voltage applications) are merely examples, and this invention is not limited to the described parameters. For example, the number of gray levels of the EPD need only be three gray levels or more.

This application claims priority from Japanese Patent Application No. 2013-056301 filed in the Japanese Patent Office on Mar. 19, 2013, the entire disclosure of which is hereby incorporated by reference in its entirely.

What is claimed is:

1. A control apparatus comprising:
an acquisition unit that acquires image data indicating an image to be displayed on a memory display element whose optical state shifts from a first gray level to a second gray level due to application of a first voltage and shifts from the second gray level to the first gray level due to application of a second voltage; and
a control unit that controls a drive circuit that drives the memory display element, so as to apply a voltage that corresponds to the image data to the memory display element,
wherein in order to set the optical state of the memory display element to a gray level indicated by the image data, the control unit controls the drive circuit so as to apply a voltage that corresponds to a pattern of voltage application in a plurality of periods that include a refresh period and a write period,
the refresh period is a period in which a voltage for alternatingly inverting the memory display element between the first gray level and the second gray level is applied, and
the number of inversions in the refresh period in a case where the memory display element is at a first temperature is lower than the number of inversions in the refresh period in a case where the memory display element is at a second temperature that is higher than the first temperature.

2. The control apparatus according to claim 1,
wherein the pattern further includes an erase period for setting the gray level of the memory display element at the beginning of the refresh period to the second gray level,
the refresh period is a period in which a voltage for setting the gray level of the memory display element at the end of the refresh period to the first gray level is applied, and
the write period is a period in which a voltage for causing the gray level of the memory display element that is the first gray level at the beginning of the write period to shift to a gray level indicated by the image data is applied.

3. The control apparatus according to claim 1,
wherein in the pattern, the length of a period in which a voltage for causing the gray level of the memory display element to shift from the first gray level to the second gray level is applied is equal to the length of a period in which a voltage for causing the gray level of the memory display element to shift from the second gray level to the first gray level is applied.

4. The control apparatus according to claim 1,
wherein the pattern is defined according to a pre-rewriting gray level, a post-rewriting gray level, and a temperature zone, and
in at least one of a case where the post-rewriting gray level is the first gray level and a case where the post-rewriting gray level is the second gray level when the pre-writing gray level is the same, the number of inversions is different between the pattern that corresponds to a first temperature zone and the pattern that corresponds to a second temperature zone that is higher than the first temperature zone.

5. The control apparatus according to claim 4,
wherein in both the case where the post-rewriting gray level is the first gray level and the case where the post-rewriting gray level is the second gray level when the pre-writing gray level is the same, the number of inversions is different between the pattern that corresponds to the first temperature zone and the pattern that corresponds to the second temperature zone that is higher than the first temperature zone.

6. The control apparatus according to claim 1,
wherein the pattern is a pattern in which one of the first voltage and the second voltage is applied for each unit period, the applied voltage being a voltage for causing a gray level change that corresponds to a portion of a loop to occur in conformity with the loop, the loop being a loop of shifting from the second gray level to the first gray level and then returning to the second gray level.

7. The control apparatus according to claim 1, further comprising:
a first storage unit that stores current data, indicating an image that is currently being displayed on the memory display element;
a second storage unit that stores next data, indicating an image that is to be displayed next on the memory display element;
a counting unit that counts the number of unit periods for which voltage application has ended among the plurality of unit periods included in the pattern; and
a third storage unit that, for each of a plurality of gray level values, stores a pre-rewriting gray level value, a post-rewriting gray level value, and a pattern of voltage application that corresponds to the pre-rewriting gray level value and the post-rewriting gray level value,
wherein the acquisition unit acquires the current data from the first storage unit and acquires the next data from the second storage unit, and
the control unit controls the drive circuit that drives the memory display element, so as to apply to the memory display element, among the voltages indicated by the plurality of patterns stored in the third storage unit, the voltage that is to foe applied in the unit period that corresponds to the current data and the next data that were acquired by the acquisition unit and corresponds to the number counted by the counting unit.

8. An electro-optic apparatus comprising:
a memory display element whose optical state shifts from a first gray level to a second gray level due to application of a first voltage and shifts from the second gray level to the first gray level due to application of a second voltage;
an acquisition unit that acquires image data indicating an image to be displayed on the memory display element; and
a control unit that controls a drive circuit that drives the memory display element, so as to apply a voltage that corresponds to the image data to the memory display element,
wherein in order to set the optical state of the memory display element to a gray level indicated by the image data, the control unit controls the drive circuit so as to apply a voltage that corresponds to a pattern of voltage application in a plurality of periods that include a refresh period and a write period,
the refresh period is a period in which a voltage for alternatingly inverting the memory display element between the first gray level and the second gray level is applied, and
the number of inversions in the refresh period in a case where the memory display element is at a first temperature is lower than the number of inversions in the refresh period in a case where the memory display element is at a second temperature that is higher than the first temperature.

9. An electronic device comprising the electro-optic apparatus according to claim 8.

10. A control method of an electro-optic apparatus, comprising:
acquiring image data indicating an image to be displayed on a memory display element whose optical state shifts from a first gray level to a second gray level due to application of a first voltage and shifts from the second gray level to the first gray level due to application of a second voltage; and
applying, in order to set the optical state of the memory display element to a gray level indicated by the image data, a voltage that corresponds to a pattern of voltage application in a plurality of periods that include a refresh period and a write period,
wherein the refresh period is a period in which a voltage for alternatingly inverting the memory display element between the first gray level and the second gray level is applied, and
the number of inversions in the refresh period in a case where the memory display element is at a first temperature is lower than the number of inversions in the refresh period in a case where the memory display element is at a second temperature that is higher than the first temperature.
